(19) United States
(12) Patent Application Publication
(10) Pub. No.: US 2025/0324324 A1
(43) Pub. Date: Oct. 16, 2025

(54) CONFIGURABLE BREAKOUT EDGE DATA CENTERS

(71) Applicant: DISH Wireless L.L.C., Littleton, CO (US)

(72) Inventors: Dawood Shahdad, Aurora, CO (US); Steven Wilson, Aurora, CO (US); Ravi Madhavan, Naperville, IL (US)

(21) Appl. No.: 19/176,766

(22) Filed: Apr. 11, 2025

Related U.S. Application Data
(60) Provisional application No. 63/633,286, filed on Apr. 12, 2024.

(51) Int. Cl. H04W 28/08; H04W 40/12; H04W 40/24

(52) U.S. Cl. CPC H04W 28/0867; H04W 40/12; H04W 40/248

(57) ABSTRACT

A method for providing scalable telecommunications services may include generating first network function within a virtual private cloud (VPC), the first network function. The method may include providing a first IP address associated with the first network function to a router server, the router server configured to manage data routing within the VPC. The method may include generating a second network function within the VPC, the second network function configured to process data from the first network function. The method may include providing a second IP address associated with the second network function to the router server implemented on the computing system. The method may include updating a route table to include at least one of the first network function, the first load balancer, the second network function, or the second load balancer. The method may include associating the first and second network function to generate a data route.

### CROSS REFERENCE TO RELATED APPLICATIONS

This application claims priority to U.S. Provisional Patent Application No. 63/633,286, filed on Apr. 12, 2024, the disclosure of which is incorporated by reference in its entirety for all purposes.

### BACKGROUND

Cloud networks may be used to support wireless network traffic. However, current hardware and software implementations of public cloud computing are limited in increasing the throughput or capacity of the network beyond a certain aggregate capacity of the network. Additionally, various bottlenecks may exist in various components of a service change such as the data plan. This bottleneck may be more pronounced with enhanced data and voice networks, such as 5G networks.

Additionally, moving up beyond an aggregate capacity with existing network and network systems is not cost-efficient from a computational perspective. Currently, networks are created based on redundancy and maximum load requirements rather than intelligently provisioning resources as required. Even if physical layers of a network may support a higher overall throughput, software or logical limitations on how the network is structured may limit the overall operation of the network.

Thus solutions are required which can allow for intelligent provisioning of networks, reducing redundancy, and increasing overall provisioned capacity of the network.

### SUMMARY

A method for providing scalable 5G network services may include generating, by a first load balancer implemented on a computing system, first network function within a virtual private cloud (VPC), the first network function configured to perform operations to provide 5G network services. The method may include providing, by the first load balancer, a first IP address associated with the first network function to a router server implemented on the computing system, the router server configured to manage data routing within the VPC. The method may include generating, by a second load balancer implemented on the computing system, a second network function within the VPC, the second network function configured to process data from the first network function to provide 5G network services. The method may include providing, by the second load balancer, a second IP address associated with the second network function to the router server implemented on the computing system. The method may include updating, by the router server, a route table to include at least one of the first network function, the first load balancer, the second network function, or the second load balancer. The method may include associating, by the router server, the first network function and the second network function to generate a data route.

In some embodiments, the method may include receiving, from a user equipment (UE) and by a gateway of the computing system, a data packet indicating an external network. The method may include transmitting, by the router server, the data packet to the first and second network functions according to the data route. The method may include transmitting, by the router server, the data packet to the external network. The method may include receiving, from the external network and by an internet gateway of the computing system, a return packet indicating the UE transmitting, by the router server, the return packet to the second and first network functions according to the data route. The method may include transmitting, by the router server, the return packet to the UE. The VPC is configured to perform operations on a data plane of a 5G network. The router server may include an endpoint configured to receive and transmit data according to the data route. The first network function may be associated with a first 5G interface, and the router server may include an endpoint configured to operate according to the first 5G interface. The VPC may be implemented on a publicly available cloud network.

A telecommunications network management system may include a router server may include: a route table, a first endpoint, and a second endpoint. The system may include a local gateway. The system may include a centralized unit (CU) cluster with a first load balancer. The system may include a user plane function (UPF) cluster with a second load balancer. The system may include an internet gateway. The system may include one or more processors. The system may include a computer readable memory may include instructions that, when executed by the one or more processors, cause the system to perform operations to: receive, by the local gateway, a data packet from a user equipment (UE). The system may transmit, by the local gateway and to the first load balancer, the data packet to the first load balancer of the CU cluster. The system may process, by an instance implemented on the CU cluster, the data packet. The system may transmit, by the first load balancer, the data packet from the instance implemented on the CU cluster to the first endpoint. The system may determine, by the route server and using data included in the route table, an instance implemented on the UPF cluster associated with the instance implemented on the CU cluster. The system may transmit, by the route server and via the second endpoint, the data packet to the instance implemented on the UPF cluster, the second load balancer, or some combination thereof; process, by the instance implemented on the UPF cluster, the data packet. The system may transmit, by the instance implemented on the UPF cluster, the data packet to the internet gateway.

In some embodiments, the data packet may be transmitted to the internet gateway via the router server. The router server may be further configured to support border gateway protocol (BGP). The first and second load balancers may be configured to instantiate a new instance on the CU cluster and the UPF cluster, respectively, in response to increased network traffic. The first and second load balancers may transmit data indicating IP addresses of the new instances to the router server, such that the route table is updated. The system may include a firewall plane. The data packet may include voice data and the system transmits the data packet to a second route server.

A non-transitory computer-readable medium may include instructions that, when executed by one or more processors, cause the one or more processors to perform operations. The operations may include generating, by a first load balancer implemented on a computing system, first network function within a virtual private cloud (VPC), the first network function configured to perform operations to provide 5G network services. The operations may include providing, by the first load balancer, a first IP address associated with the first network function to a router server implemented on the computing system, the router server configured to manage data routing within the VPC. The operations may include generating, by a second load balancer implemented on the computing system, a second network function within the VPC, the second network function configured to process data from the first network function to provide 5G network services. The operations may include providing, by the second load balancer, a second IP address associated with the second network function to the router server implemented on the computing system. The operations may include updating, by the router server, a route table to include at least one of the first network function, the first load balancer, the second network function, or the second load balancer. The operations may include associating, by the router server, the first network function and the second network function to generate a data route.

### BRIEF DESCRIPTION OF THE DRAWINGS

FIG. 1A illustrates an embodiment of a cellular network system, according to certain embodiments of the present invention.

FIG. 1B illustrates an exemplary core, according to certain embodiments of the present invention.

FIG. 2 illustrates an embodiment of a cellular network core network topology as implemented on a public cloud-computing platform, according to certain embodiments of the present invention.

FIG. 3 illustrates an exemplary system related to traffic routing according to embodiments of the present invention of the present invention.

FIG. 4 illustrates an exemplary system related to traffic routing according to embodiments of the present invention.

FIG. 5 illustrates an exemplary system related to traffic routing according to embodiments of the present invention.

FIG. 6 illustrates an exemplary system related to traffic routing according to embodiments of the present invention.

FIG. 7 illustrates an exemplary method related to modifying service chains according to embodiments of the present invention.

FIG. 8 illustrates an exemplary method related to adjusting network configurations according to embodiments of the present invention.

FIG. 9 illustrates a flow chart of a method for providing scalable 5G network services, according to certain embodiments.

### DETAILED DESCRIPTION

Cellular communications may rely on various network functions in order to provide cellular services to user equipment (UE). The network functions may be applications, software, etc. implemented on physical and/or virtual machines. Because network traffic on a mobile network may vary, it may be beneficial to implement at least some network functions on in a cloud-environment (e.g., a publicly-available cloud service such as AWS, Microsoft Azure, Oracle, etc.).

In the context of public clouds used for telecommunications networks (e.g., 5G and other cellular communications), existing systems and configurations can use an “overlay” network and may require two service chains for redundancy and load balancing requirements in a virtual environment while only one of the chains is actively being used. Thus, 50% of the provisioned capacity may be unused and requires manually intervention to switch traffic to an idle service chain in the event of a primary service chain failing.

Changing overall provisioning can require manual intervention or monitoring of the networks and network system. Additionally, various network components may become degraded causing network issues without it being known that the component is downgraded. The description below addresses these and other challenges with existing systems.

The present invention includes instantiating service chains within a public cloud environment. Each service chain may include a mobile gateway (MG) linked to a firewall component, and an internet gateway. Each service chain may be instantiated within a virtual private cloud (VPC). Data within the VPC may be managed through route server endpoints and an internet gateway route table. This configuration may enable the use of underlay routing to route data between components within the VPC.

The disclosed technology and systems may include the integration of a route server with multiple endpoints (e.g., Router Server (RS) EP), facilitating efficient traffic routing and control information management. This setup ensures that traffic can be dynamically redirected to alternative pathways, enhancing network flexibility and resilience. Additionally, an internet gateway can be used to facilitate traffic communication through each internet gateway.

A Virtual Private Cloud (VPC) may be a secure, isolated section of a cloud computing environment provided by a public cloud provider. It allows users to create and manage a virtual network within the cloud, where they can deploy cloud resources such as virtual machines, storage, and applications.

A Route Server (RS) may be a specialized server used in Internet and networking contexts, such as within Internet Exchange Points and data centers, to facilitate the exchange of routing information between different networks. It acts as a neutral entity that allows multiple systems to easily share their routes with one another without the need for a direct BGP (Border Gateway Protocol) peering relationship between each pair of networks.

“Overlay” may refer to a network layer built on top of the existing public cloud-computing infrastructure, enabling the creation of virtual routers and facilitating advanced networking features without altering the underlying physical network system. This overlay network allows for the deployment of virtualized network resources, such as virtual routers, to connect different segments of a cloud environment or to bridge cloud resources with on-premises networks.

Underlay may refer to the inherent or underlying routing capability within a cloud network. The use of an underlay may eliminate computational costs and allows for the direct use of the network's underlying infrastructure to perform specific tasks, thereby decreasing latency.

N1, N2, N3, N4, N6 etc. refer to interfaces that may be used within the 3GPP System for telecommunication networks (e.g., 5G, 6G, 7G etc.). These interfaces may facilitate communication and various operations within the telecommunication system, connecting different network functions and components to support the delivery of telecommunication services. As further explained herein, various interfaces may be used at various parts of a route or for different types of data. Reference to specific 3GPP system components, interfaces, and/or process is purely exemplary and each feature may be interchangeable with analogous components, interfaces, and/or other networking systems (e.g., nomenclature for different 3GPP cellular generations standards and/or other standards such as Wi-Fi networking standards provided by the Institute of Electrical and Electronics Engineers (IEEE)), where applicable.

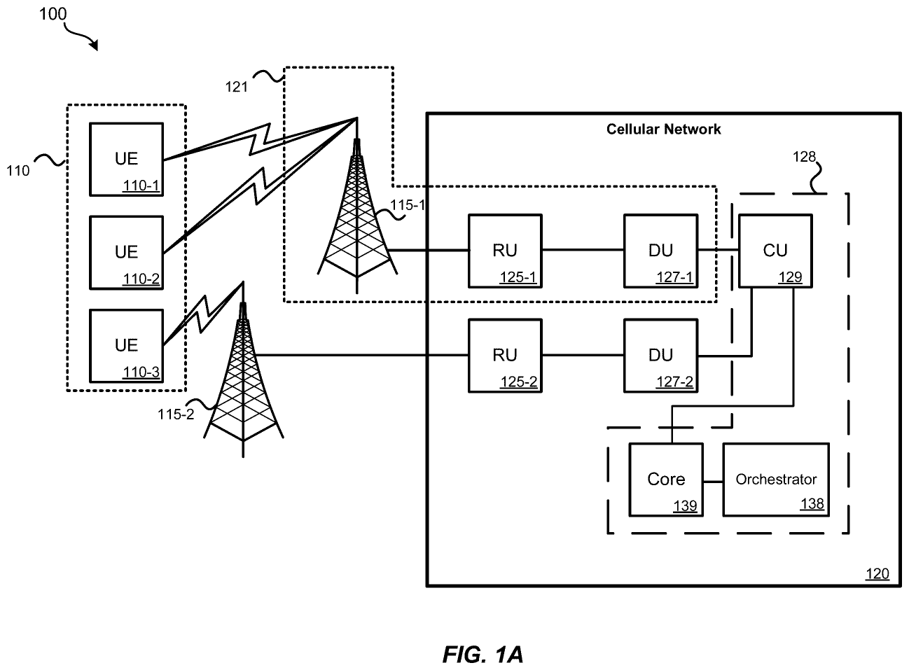

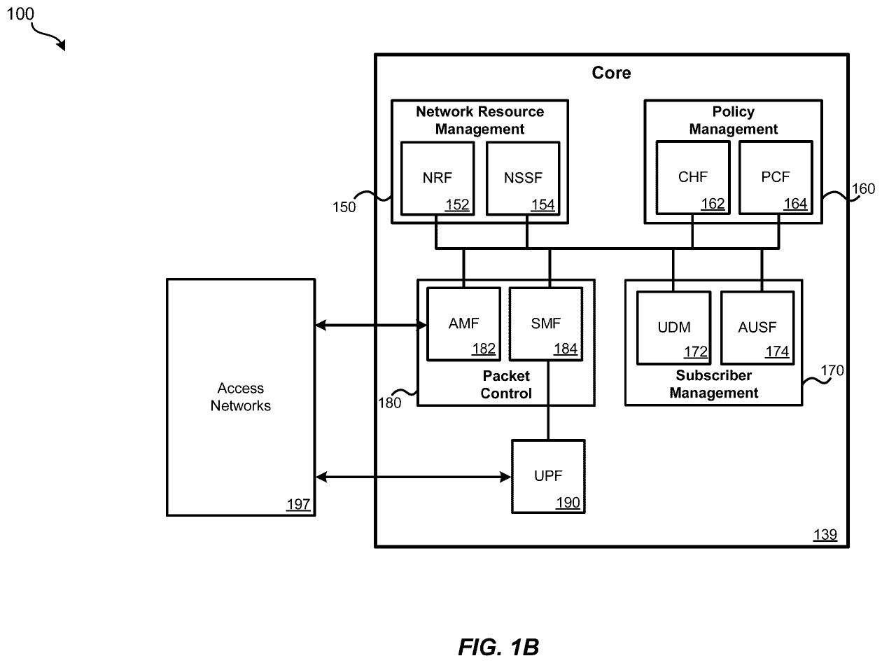

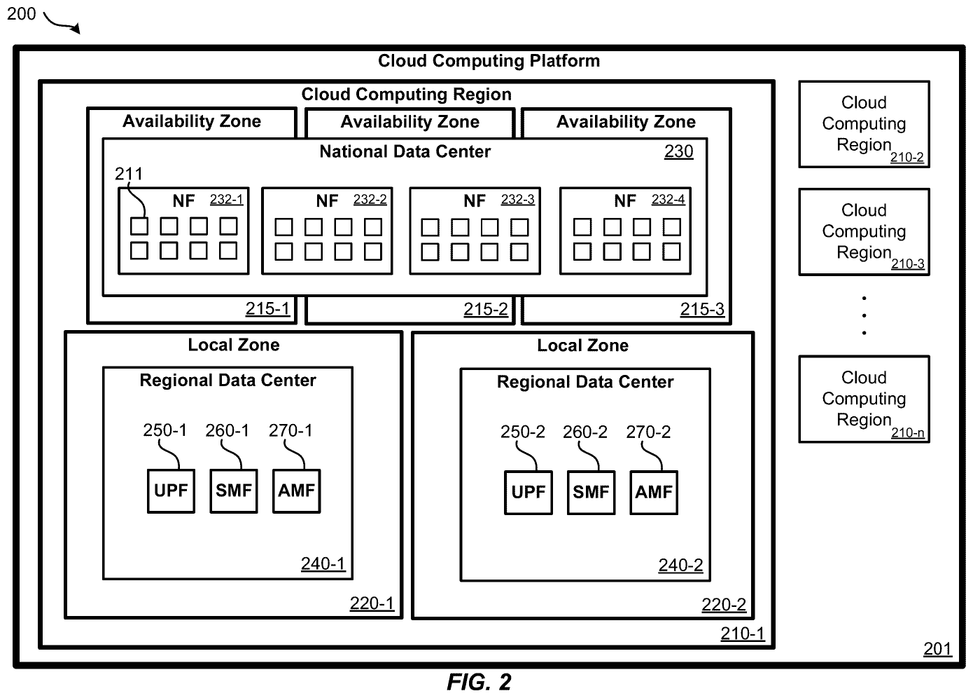

FIG. 1A illustrates an embodiment of a cellular network system 100 (“system 100”), according to certain embodiments. System 100 can include a fifth generation (5G) New Radio (NR) cellular network; other types of cellular networks, such as fourth generation (4G) long-term evolution (LTE) cellular network, sixth generation (6G) cellular network, seventh generation (7G) cellular network, etc. are also possible. System 100 can include: UE 110 (UE 110-1, UE 110-2, UE 110-3); base station 115; cellular network 120; radio units 125 (“RUs 125”); distributed units 127 (“DUs 127”); centralized unit 129 (“CU 129”); core 139, and orchestrator 138. FIG. 1A represents a component level view. In a virtualized open radio access network (O-RAN), because components can be implemented as software in the cloud, except for components that receive and transmit RF, the functionality of various components can be shifted among different servers, for which the hardware may be maintained by a separate (e.g., public) cloud-service provider, to accommodate where the functionality of such components is needed, such as detailed in relation to FIG. 2.

UE 110 can represent various types of end-user devices, such as smartphones, cellular modems, cellular-enabled computerized devices, sensor devices, manufacturing equipment, gaming devices, access points (APs), any computerized device capable of communicating via a cellular network, etc. UE can also represent any type of device that has incorporated a cellular (e.g., 5G) interface, such as a 5G modem. Examples include sensor devices, Internet of Things (IoT) devices, manufacturing robots; unmanned aerial (or land-based) vehicles, network-connected vehicles, environmental sensors, etc. UE 110 may use RF to communicate with various base stations of cellular network 120. Two base stations 115 (BS 115-1, 115-2) are illustrated. Real-world implementations of system 100 can include many (e.g., hundreds, thousands) base stations, and many RUs, DUs, and CUs. BS 115 can include one or more antennas that allow RUs 125 (e.g., RU 125-1 and RU 125-2) to communicate wirelessly with UEs 110. RUs 125 can represent an edge of cellular network 120 where data is transitioned to wireless communication. In some implementations, the radio access technology (RAT) used by RU 125 is 5G New Radio (NR). Other implementations use other RAT, such as 4G Long Term Evolution (LTE). The remainder of cellular network 120 may be based on an exclusive 5G system, a hybrid 4G/5G system, a 4G system, or some other cellular network system. Base station equipment 121 may include an RU (e.g., RU 125-1) and a DU (e.g., DU 127-1) located on site at the base station. In some embodiments, the DU may be physically remote from the RU. For instance, multiple DUs may be housed at a central location and connected to geographically distant (e.g., within a couple of kilometers) RUs.

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, “band 71” (a radiofrequency band near 600 Megahertz allocated for cellular communications). One or more DUs, such as DU 127-1, may communicate with CU 129. Collectively, RUs, DUs, and CUs create a gNodeB, which serves as the radio access network (RAN) of cellular network 120. CU 129 can communicate with core 139. The specific system of cellular network 120 can vary by embodiment. Edge cloud server systems outside of cellular network 120 may communicate, either directly, via the Internet, or via some other network, with components of cellular network 120. For example, one or more DUs 127-1 may be able to communicate with an edge cloud server system without routing data through CU 129 or core 139.

At a high level, the various components of a gNodeB can be understood as follows: RUs perform RF-based communication with UE. DUs support lower layers of the protocol stack such as the radio link control (RLC) layer, the medium access control (MAC) layer, and the physical communication layer. CUs support higher layers of the protocol stack such as the service data adaptation protocol (SDAP) layer, the packet data convergence protocol (PDCP) layer and the radio resource control (RRC) layer. A single CU can provide service to multiple co-located or geographically distributed DUs. A single DU can communicate with multiple RUs.

Further detail regarding exemplary core 139 is provided in relation to FIG. 1B.

FIG. 1B illustrates an exemplary core 139, according to certain embodiments. The exemplary core 139 can be physically distributed across data centers or located at a central national data center (NDC), such as detailed in relation to FIG. 2, can perform various core functions of the cellular network. Core 139 can include: network resource management components 150; policy management components 160; subscriber management components 170; and packet control components 180. Individual components may communicate via a bus, thus allowing various components of core 139 to communicate with each other directly. Core 139 is simplified to show some key components. Implementations can involve additional components.

Network resource management components 150 can include: Network Repository Function (NRF) 152 and Network Slice Selection Function (NSSF) 154. NRF 152 can allow 5G network functions (NFs) to register and discover each other via a standards-based application programming interface (API). NSSF 154 can be used by AMF 182 to assist with the selection of a network slice that will serve a particular UE (e.g., UEs 110 of FIG. 1A).

Policy management components 160 can include: Charging Function (CHF) 162 and Policy Control Function (PCF) 164. CHF 162 allows charging services to be offered to authorized network functions. Converged online and offline charging can be supported. PCF 164 allows for policy control functions and the related 5G signaling interfaces to be supported.

Subscriber management components 170 can include: Unified Data Management (UDM) 172 and Authentication Server Function (AUSF) 174. UDM 172 can allow for generation of authentication vectors, user identification handling, NF registration management, and retrieval of UE individual subscription data for slice selection. AUSF 174 performs authentication with UEs.

Packet control components 180 can include: Access and Mobility Management Function (AMF) 182 and Session Management Function (SMF) 184. AMF 182 can receive connection- and session-related information from UEs and is responsible for handling connection and mobility management tasks. SMF 184 is responsible for interacting with the decoupled data plane, creating updating and removing Protocol Data Unit (PDU) sessions, and managing session context with the User Plane Function (UPF).

User plane function (UPF) 190 can be responsible for packet routing and forwarding, packet inspection, quality of service (QOS) handling, and external PDU sessions for interconnecting with a Data Network (DN) (e.g., the Internet) or various access networks 197. Access networks 197 can include the RAN of cellular network 120 of FIG. 1A.

While FIGS. 1A and 1B illustrate various components of cellular network 120, it should be understood that other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In a virtualized arrangement, specialized software on general-purpose hardware may be used to perform the functions of components such as DU 127, CU 129, and core 139. Functionality of such components can be co-located or located at disparate physical server systems. For example, certain components of core 139 may be co-located with components of CU 129.

Returning to FIG. 1A, some O-RAN implementations of the DUs 127, CU 129, core 139, and/or orchestrator 138 are implemented virtually as software being executed by general-purpose computing equipment, such as in a data center. Therefore, depending on needs, the functionality of a DU, CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100, cloud-based cellular network components 128 include CU 129, core 139, and orchestrator 138. In some embodiments, DUs 127 may be partially or fully added to cloud-based cellular network components 128. Such cloud-based cellular network components 128 may be executed as specialized software executed by underlying general-purpose computer servers. Cloud-based cellular network components 128 may be executed on a public third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested. A “public” cloud-based computing platform refers to a platform where various unrelated entities can each establish an account and separately utilize the cloud computing resources, the cloud computing platform managing segregation and privacy of each entity's data.

Kubernetes, or some other container orchestration platform, can be used to create and destroy the logical DU, CU, or 5G core units and subunits, as needed, for the cellular network 120 to function properly. Kubernetes may provide for container deployment, scaling, and management. As an example, if cellular traffic increases substantially in a region, additional logical DU or components of a DU may be deployed in a data center near where the traffic is occurring without any new hardware being deployed; rather, processing and storage capabilities of the data center would be devoted to the needed functions. When the need for the logical DU or subcomponents of the DU no longer exists (i.e., when traffic subsequently decreases), Kubernetes can allow for removal of the logical DU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new DU, orchestrator 138 can perform a pipeline of calling the DU code from a software repository incorporated as part of, or separate from, cellular network 120; pulling corresponding configuration files (e.g., helm charts); creating Kubernetes nodes/pods; loading DU containers; configuring the DU; and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet particular service level agreement (SLA) levels and parameters. By controlling the location and amount of computing and communication resources allocated to a network slice, the SLA attributes for UE on the network slice can be varied on different slices. A network slice can be configured to provide sufficient resources for a particular application to be properly executed and delivered (e.g., gaming services, video services, voice services, location services, sensor reporting services, data services, etc.). However, such allocations also account for resource limitations, such as to avoid allocation of an excess of resources to any particular UE group and/or application. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 125-1 and DU 127-1; and a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

As illustrated in FIG. 1A, UE 110 may be operating on one or more production slices of cellular network 120. As detailed later in this document, a UE that functions on a particular entity's local network may be assigned to a slice particular to the entity or a slice that provides a particular QoE for tasks to be performed by the entity's UE.

Components such as DUs 127, CU 129, orchestrator 138, and core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

FIG. 2 illustrates an embodiment of a cellular network core network topology 200 as implemented on a public cloud-computing platform, according to certain embodiments. The cellular network core network topology 200 can be an implementation of the core 139 of FIGS. 1A and/or 1B. Cellular network core network topology 200 can represent how logical cellular network groups are distributed across cloud computing infrastructure of cloud computing platform 201. Cloud computing platform 201 can be logically and physically divided up into various different cloud computing regions 210. Each of cloud computing regions 210 can be isolated from other cloud computing regions to help provide fault tolerance, fail-over, load-balancing, and/or stability and each of cloud computing regions 210 can be composed of multiple availability zones, each of which can be a separate data center located in general proximity to each other (e.g., within 600 miles). Further, each of cloud computing regions 210 may provide superior service to a particular geographic region based on physical proximity. For example, cloud computing region 210-1 may have its datacenters and hardware located in the northeast of the United States while cloud computing region 210-2 may have its datacenters and hardware located in California. For simplicity, the details of the cellular network as executed in only cloud computing region 210-1 is illustrated. Similar components may be executed in other cloud computing regions of cloud computing regions 210 (210-2, 210-3, 210-n).

In other embodiments, cloud computing platform 201 may be a private cloud computing platform. A private cloud computing platform may be maintained by a single entity, such as the entity that operates the hybrid cellular network. Such a private cloud computing platform may be only used for the hybrid cellular network and/or for other uses by the entity that operates the hybrid cellular network (e.g., streaming content delivery).

Each of cloud computing regions 210 may include multiple availability zones 215. Each of availability zones 215 may be a discrete data center or group of data centers that allows for redundancy that allows for fail-over protection from other availability zones within the same cloud computing region. For example, if a particular data center of an availability zone experiences an outage, another data center of the availability zone or separate availability zone within the same cloud computing region can continue functioning and providing service. A logical cellular network component, such as a national data center, can be created in one or across multiple availability zones 215. For example, a database that is maintained as part of NDC 230 may be replicated across availability zones 215; therefore, if an availability zone of the cloud computing region is unavailable, a copy of the database remains up-to-date and available, thus allowing for continuous or near continuous functionality.

On a (e.g., public) cloud computing platform, cloud computing region 210-1 may include the ability to use a different type of data center or group of data centers, which can be referred to as local zones 220. For instance, a client, such as a provider of the hybrid cloud cellular network, can select from more options of the computing resources that can be reserved at an availability zone 215 compared to a local zone 220. However, a local zone 220 may provide computing resources nearby geographic locations where an availability zone 215 is not available. Therefore, to provide low latency, certain network components, such as regional data centers 240, can be implemented at local zones 220 rather than availability zones 215. In some circumstances, a geographic region can have both a local zone 220 and an availability zone 215.

In the topology of a 5G NR cellular network, 5G core functions of core 139 can logically reside as part of a national data center (NDC) 230. NDC 230 can be understood as having its functionality existing in cloud computing region 210-1 across multiple availability zones 215. At NDC 230, various network functions, such as NFs 232, are executed. For illustrative purposes, each NF 232, whether at NDC 230 or elsewhere located, can be comprised of multiple subcomponents, referred to as pods (e.g., pod 211) that are each executed as a separate process by the cloud computing region 210. The illustrated number of pods 211 is merely an example; fewer or greater numbers of pods 211 may be part of the respective 5G core functions. It should be understood that in a real-world implementation, a cellular network core, whether for 5G or some other standard, can include many more network functions. By distributing NFs 232 across availability zones 215, load-balancing, redundancy, and fail-over can be achieved. In local zones 220, multiple regional data centers 240 can be logically present. Each of regional data centers 240 may execute 5G core functions for a different geographic region or group of RAN components. As an example, 5G core components that can be executed within an RDC, such as RDC 240-1, may be: UPFs 250, SMFs 260, and AMFs 270. While instances of UPFs 250 and SMFs 260 may be executed in local zones 220, SMFs 260 may be executed across multiple local zones 220 for redundancy, processing load-balancing, and fail-over.

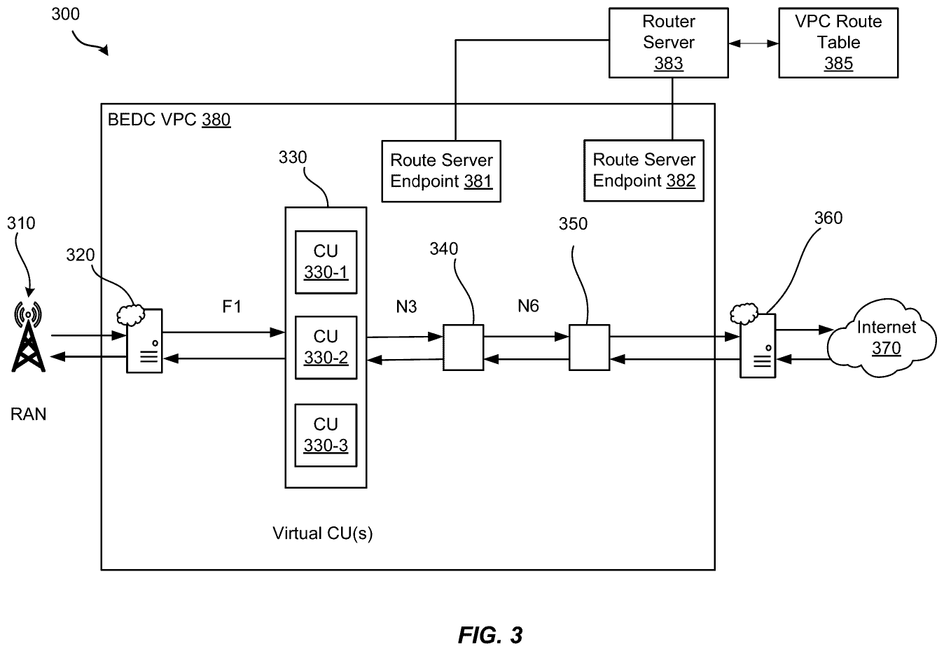

Illustrated in FIG. 3 is system 300 which may include Radio Access Network (RAN) 310, a local gateway 320, virtual Centralized Unit(s) (CUs) 330 (e.g., CU 330-1, CU 330-2, and CU 330-3), a User Plane Function-Data (UPF-D) 340, an N6 router 350, an internet gateway 360, internet 370, a BEDC VPC 380, and router server (RS) endpoints 381 and 382, and a router server (RS) 383. System 300 may include any of the components described above as well. RAN 310 may be similar to the RANs described herein, such as for example, those described above with respect to FIGS. 1A, 1B, and 2.

BEDC VPC 380 (also referred to as “VPC 380”) may be a single virtual cloud tenancy implemented on a public cloud platform. VPC 380 may be included within a virtual cloud or virtual environment. A VPC may be contained within a public cloud environment and allow a user of a VPC a virtual networking environment where they can define and control a virtual network space, including selecting IP address ranges, creating subnets, configuring route tables, and network gateways. The components and networks described herein may be instantiated on, configured on, or performed within VPC 380. For example, the VPC 380 may include one or more containerized application or services, used to implement network functions of the CUS 330-1-3, the UPF-D 340, or any other network functions.

Local gateway 320 may be a networking component (e.g., hardware and/or software) which allows resources within VPC 380 to communicate with another network, such as RAN 310. For example, data communications may be received by the VPC 380 from the RAN 310. Local gateway 320 may thus allow for direct communication from RAN 310 to one or more components within VPC 380. For example, in system 300, local gateway 320 may be in communication with virtual CUs 330. In some examples, the communication may be directed to a specific virtual CU while in other examples, the communication may be directed to the pool of virtual CUs. The local gateway 320 may include and/or access logic (e.g., a load balancer) that directs network traffic to a specific CU of the pool of virtual CUs.

Local gateway 320 may be instantiated on an isolated private cloud service within a cloud environment. Local gateway 320 may provide connectivity from an external environment to the cloud service or cloud network. Local gateway may work in conjunction with one or more elements within VPC 380 to enable one or more features described herein. In some examples, local gateway 320 may interact with RAN 310 and forward information to one or more computing units within Virtual CUs 330. In some examples, an F1 interface of the 5G standard may be used to connect the RU with other elements within VPC 380. The F1 interface may support control plane and user plane separation. The F1 interface may also separate Radio Network Layers and Transport Network Layers. The F1 interface may support the exchange of signaling and data information between the endpoints.

Virtual CUs 330 may contain one or more centralized units (CUs). Virtual CUs may be configured and capable of performing functions related to the core network, such as controlling the base stations, managing resources, and handling user mobility. In a cloud-native 5G network, this unit can be virtualized on the cloud network. Because the CUS 330-1-3 are virtual, additional virtual CUs may be spun up in response to network traffic, improving the flexibility and scalability of the 5G network.

Virtual CUs 330 may then transmit information to a UPF-D 340. UPF-D 340 may include additional components such as load balancers and other network functions, configured to perform operations to enable 5G cellular functionality. Load balancers may assist with balancing loads the various network components. The communication between the Virtual CU(s) 330 and UPF-D 340 may be done through a suitable network interface. For example, a 5G N3 interface performs the role of conveying user data from a Radio Access Network to the User Plane Function, making it possible to create both low- and high-latency services. In some examples, the interface may also be virtualized, scalable, and modifiable within VPC 380. Some or all of the components of the UPF-D 340 may be instances of one or more network functions. These instances may be instantiated in a one-to-one relationship with the number of CUs 330. For example, the CU 330-1 may have a corresponding set of instances within the UPF-D 340. All of the data processed by the CU 330-1 may be transmitted to and processed by the corresponding set of instances. The CUS 330-2 and 330-3 may include similarly corresponding sets of instances.

N6 router 350 may be a router or other network component which is capable of interaction with UPF-D 340 and transmitting data or other information to internet gateway 360. N6 router interface may be an interface which is between UPF-D 340 and a data network, such as the internet. In some embodiments, the N6 interface enables access to internet 370 through an internet gateway 360. Although an N6 router 350 is described, other routers or configurations may be used. Some or all of the components of the N6 router 350 may be instances of one or more network functions. These instances may be instantiated in a one-to-one relationship with the number of CUs 330. For example, the CU 330-1 may have a corresponding set of instances within the N6 router 350. All of the data processed by the CU 330-1 may be transmitted to and processed by the corresponding set of instances. The CUS 330-2 and 330-3 may include similarly corresponding sets of instances.

Internet gateway 360 may be a component which allows communication between VPC 380 and internet 370. Internet gateway may allow data to be transmitted through public subnets to interact with the internet. Private subnets within VPC 380 may be accessed by sources external to VPC 380 through internet gateway 360 through a Network Address Translation (NAT) service, which may be included within the functionality of Internet gateway 360. Internet gateway 360 can further enable routing of packets or information to various components of VPC 380 between addresses on internet 370. In some examples, Internet gateway 360 may receive information from N6 router 350. In some examples, the internet gateway may be scalable to allow multiple channels of data to be transmitted and received. For example, an internet gateway may be horizontally scaled and may contain redundant instances. Thus, while only one internet gateway is illustrated, a person of skill in the art will appreciate on or more internet gateways may exist to service data chains.

Internet gateway may support supports IPv4 and IPv6 traffic. In some examples, the internet gateway is not managed directly by the VPC but is a component of a public cloud provider. The internet gateway may be considered to always be available and not limited by bandwidth or availability constraints of network traffic. Internet gateway (IGW) 360 may be considered to be “attached” to VPC 380

A data path (or route) within the VPC 380 may therefore be defined as follows. Data enters the route via the local gateway 320. Then, the data may be transmitted to one or the CUS 30 via the F1 interface. Each of the CUs 330 may have a network identifier, such as an IP address, subnet gateway, and/or other such identified. Then, the may be transmitted to an instance of the UPF-D 340 via the N3 interface, and then to a corresponding instance of the N6 router 350. Then, the data may be transmitted to the IGW 360 and out to an external resource (e.g., the internet 370).

If the VPC 380 only included a single CU (and single corresponding instance of other network functions), routing may not be challenging. Similarly, if the there were any static number of CUs and corresponding network functions, routing may be relatively simple. However, implementing scalable VPCs poses challenges. When network traffic exceeds a certain level, additional instances of the CUs 330 may be required. As such, additional instances of UPF-D 340 and the N6 router 350 may also be required. As each instance of each component is spun up, a new data route must be created and logged so that traffic may be transmitted and received by the proper devices/networks/etc. In traditional systems, each component within the VPC 380 may need to be updated with the new data path—even if there is a one-to-one relationship between components, each components may need to be pointed at the correct partner component (e.g., with an IP address). This may introduce risk of failure and take time and computing resources in order to properly configure each component upon instantiation.

As illustrated in FIG. 3 a router service 383 and route service (RS) endpoints 381-2, may be implemented to address the issues above. Route server 383 may be a service configured to manage traffic within VPC 380. The route server 383 may be automated or semi-automated to assist with route management, including improving, optimizing, or dynamically updating routing topologies or network paths based on network conditions. In some examples, route server 383 may interact with other network components such as the CU 330, the local gateway 320 and one or more of UPF-D 340 and/or the N6 Router 350 (as well as other components not shown). The route server 383 may utilize various protocols (e.g., Border Gateway Protocol (BGP)) to manage the routing of traffic. The RS endpoints 381 and 382, may be to a specific components with static addresses within the VPC 380, configured to send and receive traffic. The RS endpoint 381, RS endpoint 382, and Route Server 383 may work in conjunction with one another to enable dynamic configuration of network configuration. As such, each of the RS endpoints 381-382 may be associated with a single interface. For example, the RS endpoint 381 may be associated with the N3 interface, and direct traffic from the CU 330 to the UPF-D 340. The RS endpoint 382 may direct traffic between the UPF-D 340 and the N6 router 350. Although RS endpoint 381 and RS endpoint 382 are illustrated, additional endpoints may be established. For example, additional endpoints may be included based on networking standards or protocols (e.g., N3, N4, N6). In some embodiments, the route server components may establish routing within VPC 380 and to components external to VPC 380, such as RAN 310, internet gateway 360, other VPCs within a public cloud environment, or with internet 370.

The router server 383 may also access and/or create/maintain a VPC route table 385. The VPC route table 385 may include a list of all components within the VPC and the associated IP addresses. When a new instance of a component is spun up, the router server 383 may receive information indicating the new instance and its IP address, then create or modify an entry within the route table. For example, a new CU may be instantiated due to network traffic demands. The router server 383 may then receive the IP address for the new CU, as well as new a UPF-D and/or a new N6 router 350. Because the router server 383 may manage all communication within the VPC 380, only the router server 383 and the route table 385 may be updated, instead of updating each component.

The router server 383 may then associate the new components in the VPC route table 385 in order create a new data path (or route). Thus, when data is received and directed to the new CU, the data may be transmitted by the router server 383 to the appropriate UPF-D, N6 router, and finally the IGW 360 using the RS endpoints 381-2. When data is received from the internet 370 (e.g., in response to the initial data transmitted out of the VPC 380), the router server 383 (utilizing the RS endpoints 381-2) may access the route in order to properly direct the data back through the VPC 380 to the appropriate UE.

The system shown in FIG. 3 may be implemented for data traffic within a telecommunications network (e.g., a 5G network, hence the UPF-D 340). If the CU 330 receives other data types (e.g., voice, SMS/MMS, etc.), the router server 383 and/or the RS endpoint 381 may direct the other data types to a different VPC, configured to handle the other datatypes. The different VPC(s) may include similar components, enabling the different VPCs to be scaled up and down as efficiently as those shown in FIG. 3.

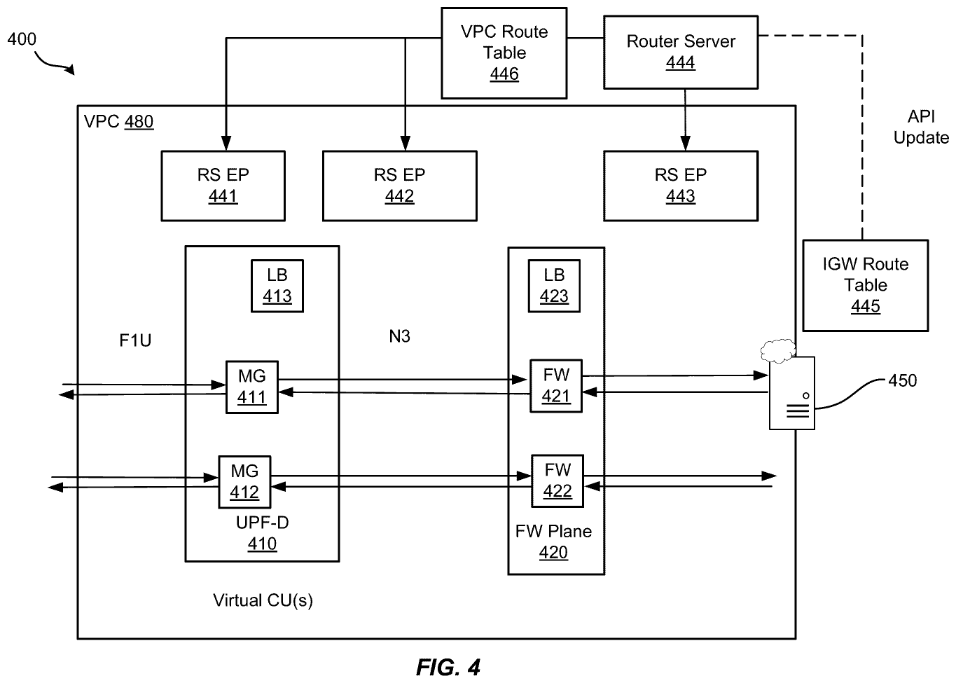

Illustrated in FIG. 4 is system 400 including a UPF-D 410, a firewall (FW) 420, an internet gateway 430, a Route Server (RS) Endpoint (EP) 441, RS EP 442, RS EP 443, a route server 444, an internet gateway route table 445, and an internet gateway (IGW) 450. The system 400 may include embodiments in which an N6 chain is scaled within a virtual cloud environment or public cloud to improve the capabilities of the network. The system 400 may be similar to some or all of system 300 described above or form a block or component of system 300. Each UPF-D 410 may contain a number of mobile gateways (MG) such as MG 411 and MG 412. UPF-D 410 may also contain a load balancer (LB) 413.

IGW 450 may be used and attached to a Radio Access Network Virtual Private cloud (e.g., one or more components of system 400). User Equipment (UE) IP pools may be assigned and attached to pools in the IGW 450 to direct internet traffic. A route server, such as router server 444 may be used to manage user equipment (UE) IP pools traffic from IGW 450 to one or more mobile gateways (e.g., MG 411 and MG 412).

Additionally, system 400 may include the following features, structures, components, or configurations of components. In some embodiments, an internet gateway (IGW) may be created and attached to a RAN related virtual private cloud. The IGW may thus provide internet connectivity from the RAN. System 400 or a VPC may also include a pool of IP addresses, which may be referred to as an IP pool. The IP pool may include both static and dynamic IP addresses. The IP pool may be a User Equipment (UE) IP pool, and include custom defined resources which may be contained within the pool.

System 400 may be “scaled out” using virtual machines to create multiple chains to scale and enhance data capabilities within the system. The scaling process may include the use of load balancer 413 to increase or decrease the number of mobile gateways within UPF-D 410 to scale out a number of chains to and from internet gateway 450. Route server can be used to manage UE IP pools traffic from the internet gateway to the mobile gateways. Each chain may allow for data to be transmitted across system 400 independently of other chains. Thus, additional chains may allow for the throughput of the network to be increased, and thus allow the number of independent connections from a RAN to other components through system 400 to be increased. Additionally, each chain may use different routing protocols (e.g., N3 or N6) within the virtual private cloud to increase the speed or efficiency of routing by leveraging the native routing abilities of the network.

Also illustrated in FIG. 4 is an “N6” chain or “N6” sub-component which can be scaled out. As illustrated, within the UPF-D 410 are multiple MGs (e.g., MGs 411 and 412) as well as load balancer 413. In some examples, load balancer 413 may be responsible for instantiating and removing mobile gateways according to requests received, traffic received, number of requests received, and/or based on other commands. The load balancer 413 may transmit the IP address and/or other identifiers to the router server 444 (e.g., via the RS EP 441). The RS EP 441 may direct data traffic within the VPC 480 (e.g., between an local gateway and UPF-D 410). The router server 444 may update the VPC route table 446 to include the IP addresses of each of the new MGs created within the UPF-D 410.

Each MG may be in communication with a firewall instance (FW) 421-422, which are contained within or instantiated within a firewall plane 420. For instance, FW 421 and 422 may be in communication with MG 411 and MG 412 respectively. The router server 444 may update the VPC route table 446 to relate the IP addresses of the MG 411-412 with those of the FW 421-422, respectively. Then, the router server 444 (via the RS EP 443) may forward the data to Internet Gateway 430.

Internet gateway 430 may operate in conjunction with internet gateway route table 445. An Internet Gateway Route Table in networking or cloud services may enable management the flow of network traffic within a Virtual Private Cloud (VPC) and between the VPC and the internet. As illustrated in FIG. 4, in some embodiments, traffic entering from the internet gateway be directed to the MG 411 and MG 412 through FW 421 and FW 422 respectively, which may be contained within firewall 420. The information may be routed through an underlay network (e.g., using an N3 interface). This enables low latency in information being routed.

The load balancer 423 may create additional firewalls as needed in order to maintain a one to one relationship with the mobile gateways of the UPF-D. For example, the LB 413 may instantiate a new MG in order to scale up for an increased traffic load within the VPC 480. The LB 413 may then provide the IP address of the new MG to the router server 444, causing the VPC route table 446 to be updated. Then, the LB 423 may cause a corresponding firewall instance to be created, and transmit an IP address associated with the new firewall to the router server 444. Thus, when scaling up the VPC 480, only one component may be reconfigured in order to properly route data—the router server 444. In current systems, each component may be updated in order to ensure that data is properly routed through the VPC 480. By utilizing the system 400, the VPC may be scaled up faster with fewer chances of error/failure, as the router server 444 is the only entity responsible for routing traffic.

In some examples, FW 421 and FW 422 may include virtual firewalls, which are created to independently perform firewall functions for each chain. However, other firewall configurations and firewall software may be used within FW plane 420. The firewall(s) may provide public cloud security. In some examples, the firewalls may also utilize artificial intelligence or machine learning based algorithms to protect workloads and system 400. Further, FW plane 420, and components thereof may be integrated with load balancers and auto-scaling features of the VPC to ensure that a sufficient number of firewalls are available at all times.

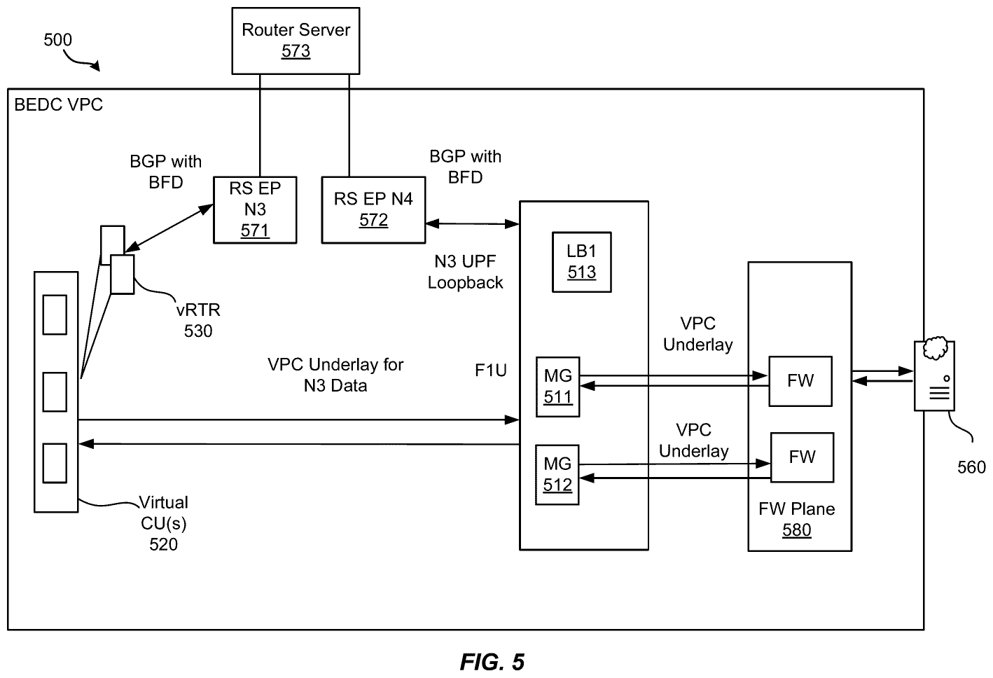

Illustrated in FIG. 5 is system 500. Virtual CU(s) 520, vRTR 530, UPF-D 540, firewall (FW) plane 550, internet gateway 560, and route server end points 571, 572, and router server 573. System 500 may be part of an “N3” system. System 500 may be used to transition from any existing system to this system through gradual transition from an overlay to an underlay to minimize packet losses during the transition of routes. Mobile gateways (MGs) 511 and 512 may interact with FW plane 550, and internet gateway 560 through an underlay which may increase throughput, and allow additional control when instantiating one or more chains or components of those chains. For example, a VPC underlay may be used which utilized “native” routing within the VPC environment to allow for certain types of data (e.g., N3 data).

System 500 may include the following features or configuration. Load balancers (LBs) (e.g., LB 513) within UPF-D 540 may be peered with a VPC route server network interface IP addresses (e.g., Elastic Network Interfaces (ENI) IPs). This IP addresses may be used for communication within the cloud environment or within a virtual private cloud. This may avoid the need for loopbacks. A load balancer may advertise a mobile gateway loopback to the VPC route server. One or more virtual CU(s) on the N3 interface may change the route or next hop from vRTR 530 to a gateway which is the first IP address within a subnet. vRTR 530 may also be used for access to carry traffic from a BEDC to RDC. Additionally, vRTR 530 may be paired with a route server over border gateway protocol and advertise a UPF-V loopback to the route server.

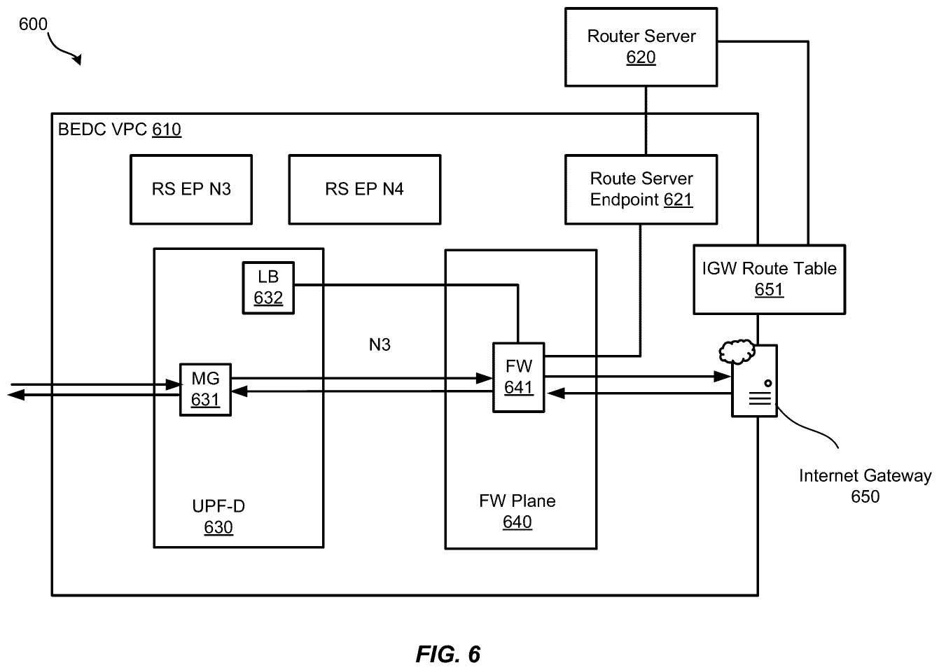

Illustrated in FIG. 6 is system 600 including a VPC 610, router server 620, route server end point 621, UPF-D 630, mobile gateway 631, load balancer (LB) 632, FW plane 640, FW 641, internet gateway 650, and internet gateway route table 651. Also illustrated are route server (RS) endpoints (EP) N3 and N4. Mobile gateway 631 may functions as an access point for mobile devices to connect to the network, often providing connectivity and data routing services for mobile users. Internet gateway may allow for the VPC 610 to connect to the internet, facilitating data exchange between the cloud resources and the external internet. Internet gateway route table 651 contains rules that determine where network traffic from the internet gateway should be directed within the VPC.

The load balancer 632 may be peered directly with the FW 641 within FW plane 640. FW 641 may be a firewall instance within a general firewall component (e.g., FW plane 640) and only conduct firewall functions with respect to the data for which it is peered. In this example, LB 632 may also cause FW plane 640 to be instantiated. Load balancer 632 may be advertised within user equipment pools with the next hop to the mobile gateway 631. The firewall internal interface may be used to integrate the components described in FIG. 6. FW 641 may be able to perform border gateway peering within the VPC 610's route server 620 to an interface external to the VPC 610. Route server 620 may be advertised to the internet gateway 650 with routing to the next hop.

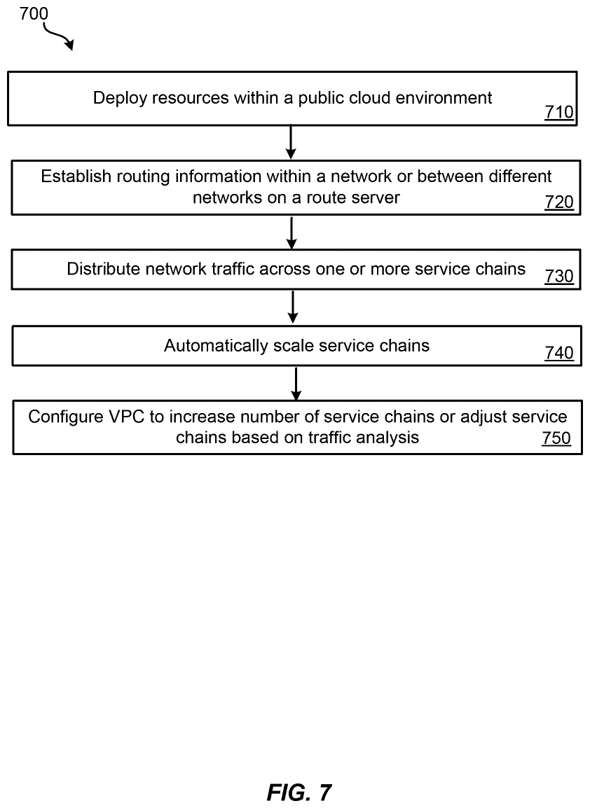

FIG. 7 illustrates a method 700 according to aspects of the disclosed technology. Method 700 may be used to manage network traffic through scaling of resources within a virtual private cloud or a public cloud environment.

At process block 710, cloud resources within a virtual private cloud (VPC) may be deployed or instantiated. The deployed resources may include any of the resources discussed above. The cloud resources which are instantiated may include configuring the resources to be scaled, eliminated, and re-used as necessary based on traffic. The instantiated resources may include, for example, route servers, end points, and mobile gateways.

At process block 720, routing information between different networks may be exchanged through a route server. The exchange or establishment of routing information may allow for optimization of data packet pathways across networks. This may in turn enhance performance and reduce latency.

At process block 730, network traffic may be distributed across multiple service chains. This step may be achieved or accomplished through the functionality of the user plane function (UPF) load balancer. The load balancer may make decisions regarding how to distribute traffic across one or more chain. Each service chain may include a mobile gateway within the UPF which is configured to interact with both a firewall instance and an internet gateway.

At process block 740, service chains may be automatically scaled up in response to exceeded traffic volume thresholds. In other examples, other criteria may be used to determine the scaling and dynamic adjustment of service chains. Dynamic adjustment allows the network to accommodate fluctuating traffic loads, ensuring seamless operation. Thus, for any “peak” traffic load, the cloud environment can be used to service the traffic load while dynamically adjusting to a lower use of cloud resources when the peak traffic load is no longer in existence.

At process block 750, the VPC is configured to adjust service chains based on real-time traffic analysis. For example, the load balancer may reduce the number of service chains or other cloud components when not required to ensure that cloud resources are available for other tasks and that unnecessary overhead is not being used. Continuous monitoring and real-time adjustments may increase network performance and improve resource utilization, concluding the method. However, the system remains vigilant, continuously monitoring and ready to adapt to traffic changes.

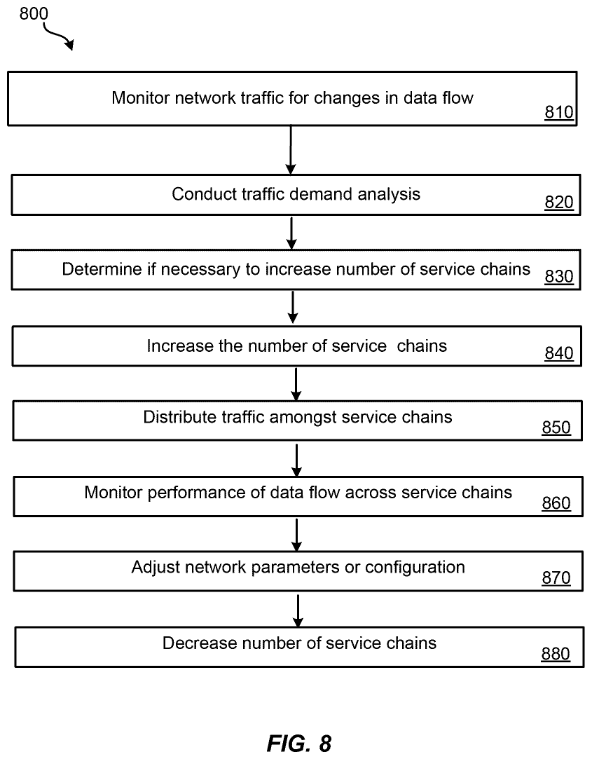

FIG. 8 illustrates a method 800 according to aspects of the disclosed technology.

At process block 810, continuous network traffic monitoring may be performed to detect any significant changes in data flow, indicating a potential need for resource or service chain adjustments.

At process block 820, a detailed traffic demand analysis may be conducted, comparing current traffic to predefined thresholds to ascertain if demand has surpassed the capacity of existing service chains, identifying scaling needs.

At process block 830, it may be determined if it is necessary to scale up service chains based on the prior analysis, dynamically responding to current network conditions and established protocols.

At process block 840, actions may be undertaken in the virtual cloud to scale up the number of service chains. This may include increasing the number of service chains or resources to manage network traffic effectively. This process may be done automatically to allow for real-time response without the need for human intervention.

At process block 850, traffic distribution may be optimized across scaled service chains through load balancing strategies. For example, the, aim may be for an even distribution to avoid bottlenecks within the traffic.

At process block 860, performance monitoring of the service chains may be conducted post-scaling to ensure that the scaling actions have effectively meet the increased traffic flow.

At process block 870 adjustments to the network may be made. For example, fine-tuning resource allocation and/or service chain configurations may be conducted based on performance data to maintain network responsiveness.

At process block 880, in response to decreased demand, the system may scale down resources or service chains to conserve resources. This ensures efficient network operation without over-provisioning.

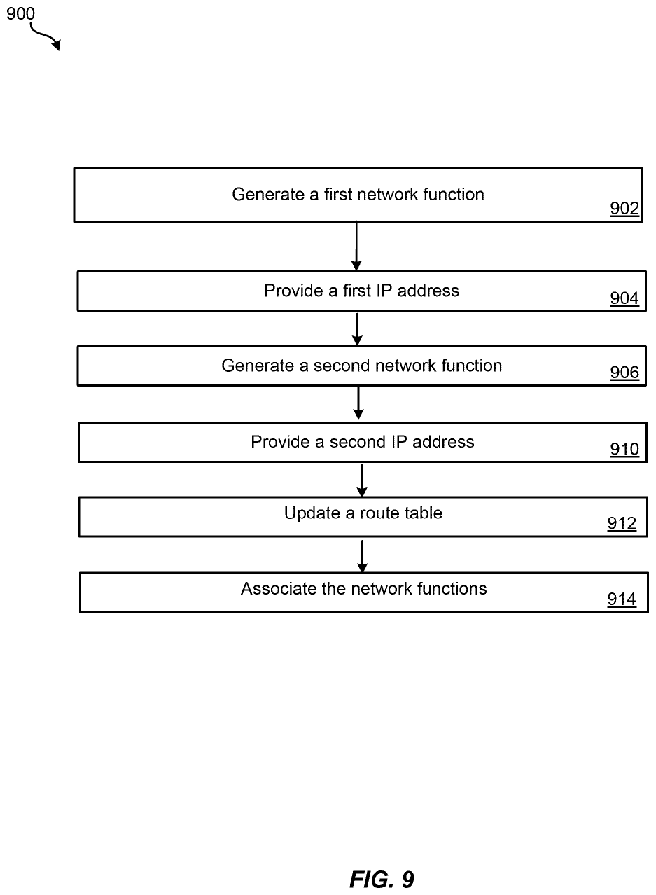

FIG. 9 illustrates a flow chart of a method 900 for providing scalable 5G network services, according to certain embodiments. The method 900 may be performed by some or all of the systems described herein, such as the systems 300, 400, 500 and 600, described in FIGS. 3-6, respectively. Some or all of steps of the method 900 may be performed in a different order than is shown here, and/or may be combined with other steps. In some embodiments, some steps may be skipped altogether.

At step 902, the method 900 may include generating, by a first load balancer implemented on a computing system, first network function within a virtual private cloud (VPC), the first network function configured to perform operations to provide 5G network services. The first load balancer may be similar to the load balancer 413 in FIG. 4. The first load balancer may be associated with a CU cluster, UPF cluster, FW cluster, etc. The first network function may be a network function of a CU, a UPF (e.g., the UPF-D 340), or any other type of network function. The computing system may include one or more physical and/or virtual machines configured to provide 5G network services to one or more user equipment (UEs). The VPC may be a cloud tenancy of a network services provider implemented on a cloud platform.

At step 904, the method 900 may include providing, by the first load balancer, a first IP address associated with the first network function to a router server implemented on the computing system, the router server configured to manage data routing within the VPC. The router server may include a route table, listing various components implemented on the VPC and associated identifiers (e.g., IP addresses). The router server may include endpoints, configured to manage some or all of the traffic handled within the VPC.

At 906, the method 900 may include generating, by a second load balancer implemented on the computing system, a second network function within the VPC, the second network function configured to process data from the first network function to provide 5G network services. The second load balancer may be similar to the load balancer 413 in FIG. 4. The second load balancer may be associated with a CU cluster, UPF cluster, FW cluster, etc. The second network function may be a network function of a CU, a UPF (e.g., the UPF-D 340), or any other type of network function.

At 908, the method 900 may include providing, by the second load balancer, a second IP address associated with the second network function to the router server implemented on the computing system.

At 910, the method 900 may include updating, by the router server, the route table to include at least one of the first network function, the first load balancer, the second network function, or the second load balancer. The route table listing various components implemented on the VPC and associated identifiers (e.g., IP addresses). The router server may utilize the route table to handle incoming and outgoing traffic within the VPC.

At 912, the method 900 may include associating, by the router server, the first network function and the second network function to generate a data route. The data route may be at least partially managed by one or more endpoints. Each of the endpoints may be configured to handle traffic according to a respective 5G interface (e.g., N3, N6, etc.). All traffic may be routed via the endpoints rather than from component to component.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks. For example, executing instructions stored in the non-transitory computer-readable medium causes the processors to perform steps of methods and/or to implement features of components described herein.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method for providing scalable telecommunication services, the method comprising:
generating, by a first load balancer implemented on a computing system, a first network function within a virtual private cloud (VPC), the first network function configured to perform operations that provide telecommunication services;
providing, by the first load balancer, a first destination address associated with the first network function to a router server implemented on the computing system, the router server configured to manage data routing within the VPC;
generating, by a second load balancer implemented on the computing system, a second network function within the VPC, the second network function configured to process data from the first network function;
providing, by the second load balancer, a second destination address associated with the second network function to the router server implemented on the computing system;
updating, by the router server, a route table to indicate at least one of the first destination address, the first load balancer, the second destination address associated with the second network function, or the second load balancer; and
generating, by the router server, a data route by associating at least on the first network function and the second network function.

2. The method of claim 1, further comprising:
receiving, from a user equipment (UE) and by a gateway of the computing system, a data packet indicating an external network;
transmitting, by the router server, the data packet to the first and second network functions according to the data route; and
transmitting, by the router server, the data packet to the external network.

3. The method of claim 2,
receiving, from the external network and by an internet gateway of the computing system, a return packet indicating a destination address associated with the UE;
transmitting, by the router server, the return packet to the second and first network functions according to the data route; and
transmitting, by the router server, the return packet to the UE.

4. The method of claim 1, wherein the VPC is configured to provide scalable network functions for a telecommunications network.

5. The method of claim 1, wherein the router server comprises an endpoint configured to receive and transmit data according to the data route.

6. The method of claim 1, wherein the first network function is associated with a first 5G telecommunications network interface, and the router server comprises an endpoint configured to operate according to the first 5G telecommunications network interface.

7. The method of claim 1, wherein the VPC is implemented on a publicly available cloud network.

8. A telecommunications network management system, comprising:
a router server comprising:
a route table;
a first endpoint; and
a second endpoint;
a local gateway;
a centralized unit (CU) cluster with a first load balancer;
a user plane function (UPF) cluster with a second load balancer;
an internet gateway;
one or more processors; and
a computer readable memory comprising instructions that, when executed by the one or more processors, cause the system to perform operations to:
receive, by the local gateway, a data packet from a user equipment (UE);
transmit, by the local gateway and to the first load balancer, the data packet to the first load balancer of the CU cluster;
process, by an instance implemented on the CU cluster, the data packet;
transmit, by the first load balancer, the data packet from the instance implemented on the CU cluster to the first endpoint;
determine, by the route server and using data included in the route table, an instance implemented on the UPF cluster associated with the instance implemented on the CU cluster;
transmit, by the route server and via the second endpoint, the data packet to the instance implemented on the UPF cluster, the second load balancer, or some combination thereof;
process, by the instance implemented on the UPF cluster, the data packet; and
transmit, by the instance implemented on the UPF cluster, the data packet to the internet gateway.

9. The system of claim 8, wherein the data packet is transmitted to the internet gateway via the router server.

10. The system of claim 8, wherein the router server is further configured to support Border Gateway Protocol (BGP).

11. The system of claim 8, wherein the first and second load balancers are configured to instantiate a new instance on the CU cluster and the UPF cluster, respectively, in response to increased network traffic.

12. The system of claim 11, wherein the first and second load balancers transmit data indicating destination addresses of the new instances to the router server, such that the route table is updated.

13. The system of claim 8, further comprising a firewall plane.

14. The system of claim 8, wherein the data packet comprises voice data and the system transmits the data packet to a second route server.

15. A non-transitory computer-readable medium comprising instructions that, when executed by one or more processors, cause the one or more processors to perform operations comprising:
generating, by a first load balancer implemented on a computing system, a first network function within a virtual private cloud (VPC), the first network function configured to perform operations that provide telecommunication services;
providing, by the first load balancer, a first destination address associated with the first network function to a router server implemented on the computing system, the router server configured to manage data routing within the VPC;
generating, by a second load balancer implemented on the computing system, a second network function within the VPC, the second network function configured to process data from the first network function;
providing, by the second load balancer, a second destination address associated with the second network function to the router server implemented on the computing system;
updating, by the router server, a route table to indicate at least one of the first destination address, the first load balancer, the second destination address associated with the second network function, or the second load balancer; and
generating, by the router server, a data route by associating at least on the first network function and the second network function.

16. The non-transitory computer-readable medium of claim 15, further comprising:
receiving, from a user equipment (UE) and by a gateway of the computing system, a data packet indicating an external network;
transmitting, by the router server, the data packet to the first and second network functions according to the data route; and
transmitting, by the router server, the data packet to the external network.

17. The non-transitory computer-readable medium of claim 16,
receiving, from the external network and by an internet gateway of the computing system, a return packet indicating the UE
transmitting, by the router server, the return packet to the second and first network functions according to the data route; and
transmitting, by the router server, the return packet to the UE.

18. The non-transitory computer-readable medium of claim 15, wherein the VPC is configured to perform operations on a data plane of a 5G network.

19. The non-transitory computer-readable medium of claim 15, wherein the router server comprises an endpoint configured to receive and transmit data according to the data route.

20. The non-transitory computer-readable medium of claim 15, wherein the first network function is associated with a first 5G interface, and the router server comprises an endpoint configured to operate according to the first 5G interface.
